(19) United States
(12) Patent Application Publication
(10) Pub. No.: US 2017/0322676 A1
(43) Pub. Date: Nov. 9, 2017

(54) MOTION SENSING METHOD AND MOTION SENSING DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JUN-WEN LI, Shenzhen (CN)

(21) Appl. No.: 15/586,259

(22) Filed: May 3, 2017

(30) Foreign Application Priority Data
May 5, 2016 (CN) 201610291409.2

(51) Int. Cl. G06F 3/042; G06K 9/00; G06K 9/62; H04N 5/33

(52) U.S. Cl. CPC G06F 3/0425; G06K 9/6202; G06K 9/00342; G06K 9/00369; H04N 5/33

(57) ABSTRACT

A motion sensing method is applied in a motion sensing device to imitate or repeat movement of human body or parts using a camera and a sensor. The method comprises detecting human body and adjusting rotation angle of an infrared sensor to track parts of the human body having acquired human body temperature distribution image from the camera. Human body contour image is analyzed and distances between a moving part of the human body and the motion sensing device are acquired. Determining a target contour image by reference to stored human body contour images and determining a corresponding two-dimensional motion. A target control signal is determined according to the determined operation and a relationship table defining a relationship between the number of operations and the number of control signals. The motion sensing device is controlled to act according to the determined target control signal.

### CROSS-REFERENCE TO RELATED APPLICATIONS

This application claims priority to Chinese Patent Application No. 201610291409.2 filed on May 5, 2016, the contents of which are incorporated by reference herein.

### FIELD

The subject matter herein generally relates to electronic product field, especially relates to a motion sensing method and a motion sensing device.

### BACKGROUND

In the prior art, somatosensory device senses the motion of human body through three-axis accelerometer, a gravity sensor, or a gyroscope, however the current somatosensory device is expensive.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a running environment of a motion sensing system.

FIG. 2 is a block diagram of an embodiment of a motion sensing device.

FIG. 3 is a block diagram of an embodiment of the motion sensing system of FIG. 1.

FIG. 4 is a flowchart of an embodiment of a motion sensing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” indicates “including, but not necessarily limited to”; it specifically indicates open-ended inclusion or membership in a so-described combination, group, series, and the like.

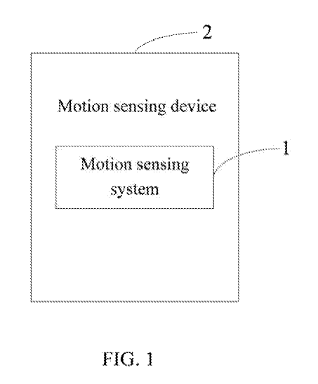

FIG. 1 illustrates an embodiment of a running environment of a motion sensing system 1. The motion sensing system 1 is run in a motion sensing device 2. The system 1 is used to acquire user's motion, and control the motion sensing device 2 according to the acquired user's motion. In at least one embodiment, the motion sensing device 2 can be a smart phone or a tablet computer.

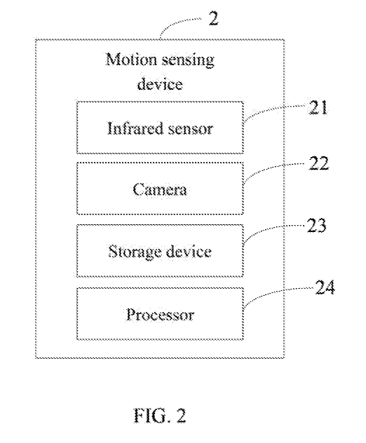

FIG. 2 illustrates the motion sensing device 2. The motion sensing device 2 includes, but not limited to, a number of infrared sensors 21, a camera 22, a storage device 23, and at least one processor 24. The number of infrared sensors 21 are arranged on the motion sensing device 2 and can rotate relative to the motion sensing device 2, and are used to detect human body and motions of human body. The camera 22 is used to acquire a human body temperature distribution image. In at least one embodiment, the camera 22 is an infrared thermal imaging camera. The storage device 23 stores a number of human body contour images and a relationship table. The relationship table defines a relationship between a number of operations and a number of control signals. Each control signal is used to operate the motion sensing device 2 correspondingly. Each human body contour image corresponds to a two-dimensional motion. The two-dimensional motion is an action which is generated by mapping an action of the human body onto a two-dimensional plane, for example, the two-dimensional motion can be an up movement, a down movement, a left movement, a right movement, and the like. The at least one processor 24 can be a central processing unit (CPU), a microprocessor, or other data processor chip that performs functions of the motion sensing system 1.

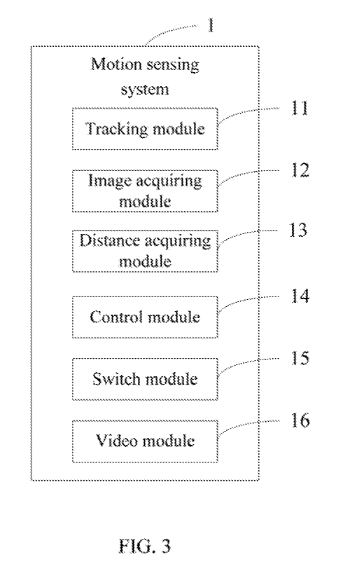

FIG. 3 illustrates the motion sensing system 1. The motion sensing system 1 includes, but not limited to, a tracking module 11, an image acquiring module 12, a distance acquiring module 13, a control module 14, a switch module 15, and a video module 16. The modules 11-16 of the motion sensing system 1 can be collections of software instructions stored in the storage device 23 and executed by the at least one processor 24. The modules 11-16 of the motion sensing system 1 also can include functionality represented as hardware or integrated circuits, or as software and hardware combinations, such as a special-purpose processor or a general-purpose processor with special-purpose firmware.

The tracking module 11 is used to detect the human body in proximity to the motion sensing device 2 and adjust the rotation angle of the infrared sensors 21 to track the human body. In at least one embodiment, the tracking module 11 controls the infrared sensors 21 to track the human body through infrared thermal imaging technology of the human body. In at least one embodiment, the tracking module 11 detects the human body temperature distribution, and adjusts the rotation angle of the infrared sensors 21 to track the human body according to the detected human body temperature distribution. As tracking the human body through infrared thermal imaging technology of the human body is prior art, the present disclosure does not disclose details.

In another embodiment, the human body wears a bracelet with positioning system, the tracking module 11 detects the human body wearing the bracelet, and adjusts the rotation angle of the infrared sensors 21 to track the human body wearing the bracelet.

The image acquiring module 12 is used to acquire the human body temperature distribution image from the camera 22, and analyses the human body contour image based on the acquired human body temperature distribution image.

The distance acquiring module 13 is used to acquire distance measurements between a moving part of the human body and the motion sensing device 2.

The control module 14 is used to compare the human body contour images acquired by the image acquiring module 12 with the stored human body contour images, and determine a target human body contour image matching with the acquired human body contour image from the stored human body contour images. A two-dimensional motion corresponding to the target human body contour image is then determined. The control module 14 further determines a corresponding operation according to the determined two-dimensional motion and the acquired distance measurements between the moving parts of human body and the motion sensing device 2, and determines a target control signal according to the determined operation and the relationship table. The control module 14 controls the motion sensing device 2 according to the determined target control signal.

In at least one embodiment, the target control signal can be an operation control signal used in a network game, and the control module 14 controls the network game by detecting motions of the fingers of the user. For example, the tracking module 11 detects the nearby human body and adjusts the rotation angle of the infrared sensors 21 to track the human body. The image acquiring module 12 acquires the human body temperature distribution image from the camera 22, and analyses the human body contour image based on the acquired human body temperature distribution image. The distance acquiring module 13 acquires distance measurements between a finger of the human body and the motion sensing device 2. The control module 14 compares the human body contour image acquired by the image acquiring module 12 with the stored human body contour images, and determines a target human body contour image matching with the acquired human body contour image from the stored human body contour images. One two-dimensional motion corresponding to the target human body contour image is determined. The control module 14 further determines a corresponding operation according to the determined two-dimensional motion and the acquired distance measurements between the finger of the human body and the motion sensing device 2, determines one operation control signal used in a network game according to the determined operation and the relationship table, and controls the network game to run in the motion sensing device 2 according to the determined operation control signal.

In another embodiment, after determining a two-dimensional motion, the control module 14 determines the corresponding operation according to the determined two-dimensional motion and the distance measurement between the moving part of human body and the motion sensing device 2. For example, when determining that the two-dimensional motion is a leftward motion and the distance measurement between the moving part of human body and the motion sensing device 2 is less than a preset distance, the control module 14 determines the corresponding operation as being a leftward operation. When determining that the two-dimensional motion is a leftward motion and the distance measurement between the moving part of human body and the motion sensing device 2 is greater than the preset distance, the control module 14 determines the corresponding operation as being a left forward operation or a left backward operation.

The switch module 15 is used to detect whether the human body touches the motion sensing device 2 through the infrared sensor 21, and starts or shuts down the motion sensing system 1 or the motion sensing device 2 when the human body touches the motion sensing device 2. In at least one embodiment, when the motion sensing system 1 is shut down and the human body touches the motion sensing device 2, the switch module 15 starts the motion sensing system 1 or the motion sensing device 2. When the motion sensing system 1 or the motion sensing device 2 is running and the human body touches the motion sensing device 2, the switch module 15 shuts down the motion sensing system 1 or the motion sensing device 2. In another embodiment, the switch module 15 starts the motion sensing system 1 or the motion sensing device 2 when detecting that a switch circuit (not shown) installed in the motion sensing device 2 is turned on, and the switch module 15 shuts down the motion sensing system 1 when detecting that the switch circuit is turned off

The video module 16 is used to record a video for a user to view when the switch module 15 starts the motion sensing system 1. When a user operates a game in the motion sensing device 2 through the motion sensing system 1, the video module 16 is capable of recording the operating motions in the game for the user to view.

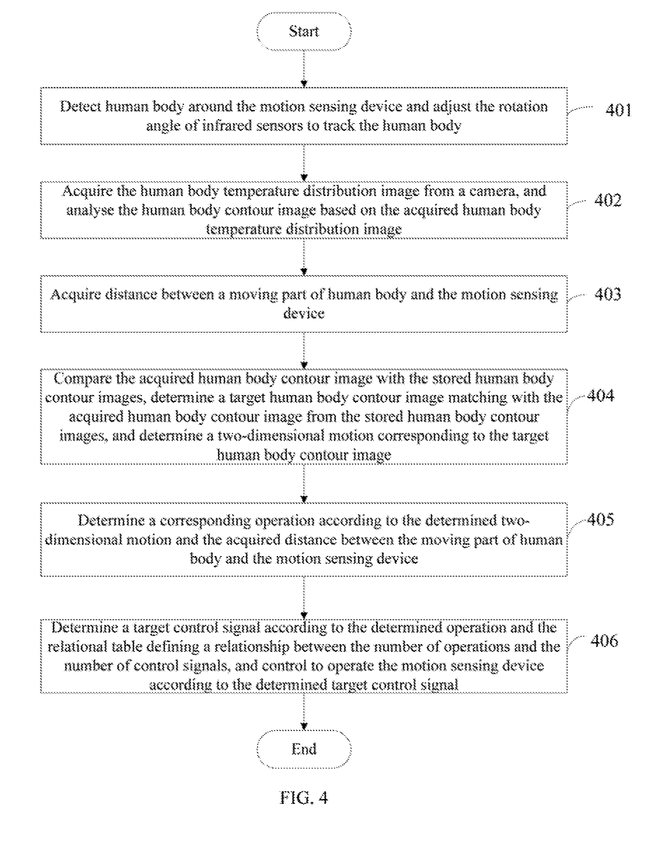

FIG. 4 illustrates a flowchart a motion sensing method. The method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, a motion sensing device detects human body in proximity to the motion sensing device and adjusting the rotation angle of infrared sensors to track the human body. In at least one embodiment, the motion sensing device detects human body temperature distribution, and adjusting the rotation angle of the infrared sensors according to the detected human body temperature distribution to track the human body. In another embodiment, the human body wears a bracelet with positioning system, the motion sensing device detects the human body wearing the bracelet with positioning system, and adjusts the rotation angle of the infrared sensors to track the human body wearing the bracelet with positioning system.

At block 402, the motion sensing device acquires the human body temperature distribution image from a camera, and analyses the human body contour image based on the acquired human body temperature distribution image.

At block 403, the motion sensing device acquires distance measurements between a moving part of human body and the motion sensing device.

At block 404, the motion sensing device compares the acquired human body contour image with the stored human body contour images, determines a target human body contour image matching with the acquired human body contour image from the stored human body contour images, and determines a two-dimensional motion corresponding to the target human body contour image.

At block 405, the motion sensing device determines a corresponding operation according to the determined two-dimensional motion and the acquired distance measurements between the moving part of human body and the motion sensing device, determines a target control signal according to the determined operation and the relationship table defining a relationship between the number of operations and the number of control signals, and controls to operate the motion sensing device according to the determined target control signal.

The method further includes: the motion sensing device detects whether the human body touches the motion sensing device through the infrared sensor, and starts or shuts down a motion sensing system when the human body touches the motion sensing device.

The method further includes: the motion sensing device records a video for a user to view when the motion sensing device starts the motion sensing system.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A motion sensing device comprising:
at least one infrared sensor configured to rotate relative to the motion sensing device and detect a human body in proximity to the motion sensing device;
a camera configured to acquire a human body temperature distribution image;
at least one processor coupled to the at least one infrared sensor and the camera;
a non-transitory storage medium coupled to the at least one processor and configured to store a plurality of instructions, which cause the motion sensing device to:
detect the human body and adjust rotation angle of the at least one infrared sensor to track the human body;
acquire a human body temperature distribution image of the human body from the camera, and analyze a human body contour image based on the acquired human body temperature distribution image;
acquire distance measurement between a moving part of the human body and the motion sensing device;
compare the acquired human body contour image with stored human body contour images, and determine a target human body contour image matching with the acquired human body contour image from the stored human body contour images, and determine a two-dimensional motion corresponding to the target human body contour image;
determine a corresponding operation according to the determined two-dimensional motion and the acquired distance measurement between the moving part of human body and the motion sensing device;
determine a target control signal according to the determined operation and a relationship table defining a relationship between the number of operations and the number of control signals; and
control the motion sensing device according to the determined target control signal.

2. The motion sensing device according to claim 1, wherein the plurality of instructions is further configured to cause the device to:
detect human body temperature distribution, and adjust the rotation angle of the at least one infrared sensor to track the human body according to the detected human body temperature distribution.

3. The motion sensing device according to claim 1, wherein the plurality of instructions is further configured to cause the device to:
detect the human body wearing a bracelet with a positioning system, and adjust the rotation angle of the at least one infrared sensor to track the human body wearing the bracelet.

4. The motion sensing device according to claim 1, wherein the plurality of instructions is further configured to cause the device to:
detect whether the human body touches the motion sensing device through the at least one infrared sensor, and start or shut down the motion sensing device when the human body touches the motion sensing device.

5. The motion sensing device according to claim 4, wherein the plurality of instructions is further configured to cause the device to:
record a video for a user to view when the motion sensing device is opened.

6. The motion sensing device according to claim 1, wherein the target control signal can be an operation control signal used in a network game.

7. The motion sensing device according to claim 1, wherein the motion sensing device can be a smart phone, or a tablet computer.

8. A motion sensing method, applied in a motion sensing device defining a camera and at least one infrared sensor, the method comprising:
detecting human body in proximity to the motion sensing device and adjusting rotation angle of the at least one infrared sensor to track the human body;
acquiring human body temperature distribution image from the camera, and analyze the human body contour image based on the acquired human body temperature distribution image;
acquiring distance measurement between a moving part of the human body and the motion sensing device;
comparing the acquired human body contour image with stored human body contour images, and determining a target human body contour image matching with the acquired human body contour image from the stored human body contour images;
determining a two-dimensional motion corresponding to the target human body contour image;
determining a corresponding operation according to the determined two-dimensional motion and the acquired distance measurement between the moving part of human body and the motion sensing device;
determining a target control signal according to the determined operation and a relationship table defining a relationship between the number of operations and the number of control signals; and
controlling the motion sensing device according to the determined target control signal.

9. The motion sensing method according to claim 8, further comprising:
detecting human body temperature distribution, and adjusting the rotation angle of the at least one infrared sensor to track the human body according to the detected human body temperature distribution.

10. The motion sensing method according to claim 8, further comprising:
detecting the human body wearing a bracelet with a positioning system, and adjusting the rotation angle of the at least one infrared sensor to track the human body wearing the bracelet.

11. The motion sensing method according to claim 8, further comprising:
detecting whether the human body touches the motion sensing device through the at least one infrared sensor, and starting or shutting down the motion sensing device when the human body touches the motion sensing device.

12. The motion sensing method according to claim 11, further comprising:
recording a video for a user to view when the motion sensing device is opened.

13. The motion sensing method according to claim 8, wherein the target control signal can be an operation control signal used in a network game.
